(19) United States
(12) Patent Application Publication
(10) Pub. No.: US 2025/0182286 A1
(43) Pub. Date: Jun. 5, 2025

(54) METHOD, APPARATUS, DEVICE AND MEDIUM FOR MULTIMODAL DATA PROCESSING

(71) Applicants: Lemon Inc., Grand Cayman (KY); Beijing Zitiao Network Technology Co., Ltd., Beijing (CN)

(72) Inventors: Xiaojie JIN, Los Angeles, CA (US); Zhongwei Ren, Beijing (CN); Zhicheng Huang, Beijing (CN); Jiashi Feng, Singapore (SG)

(21) Appl. No.: 18/963,206

(22) Filed: Nov. 27, 2024

(30) Foreign Application Priority Data
Nov. 30, 2023 (CN) 202311644031.6

(51) Int. Cl. G06T 7/10; G06T 7/70; G06T 9/00; G06V 10/44; G06V 10/80

(52) U.S. Cl. CPC G06T 7/10; G06T 7/70; G06T 9/00; G06V 10/44; G06V 10/806

(57) ABSTRACT

Embodiments of the disclosure provide a method, an apparatus, a device and a medium for multimodal data processing. The method includes: obtaining a target question and a target image associated with the target question; processing the target question and the target image by using a multimodal model to obtain an output of the multimodal model, the output including a text portion and at least one segmentation codebook for the target image indicating feature information of at least one object related to the target question; decoding the at least one segmentation codebook based on the target image by using an image decoder model to obtain at least one segmentation mask, the at least one segmentation mask indicating a region where the at least one object is located in the target image; and determining an answer to the target question based on the text portion and the at least one segmentation mask.

### CROSS-REFERENCE

The present application claims priority to Chinese Patent Application No. 202311644031.6, filed on Nov. 30, 2023 and entitled “METHOD, APPARATUS, DEVICE AND MEDIUM FOR MULTIMODAL DATA PROCESSING,” the entirety of which is incorporated herein by reference.

### FIELD

Example embodiments of the present disclosure generally relates to machine learning and, in particular, to a method, an apparatus, a device and computer-readable storage medium for multimodal data processing.

### BACKGROUND

With the development of machine learning technology, machine learning models have been utilized to perform tasks in a variety of application environments. Cross-modal comparative learning is a machine learning method that utilizes correlations between multimodal data (such as images, video, text, audio, etc.) to learn the representation of each modality. Video/image question-answering is a common task in the field of vision and language. In question-answering tasks, an answer to a question needs to be searched for from a video or an image, and thus image segmentation and inference usually need to be performed.

### SUMMARY

In a first aspect of the present disclosure, there is provided a method for multimodal data processing. The method includes: obtaining a target question and a target image associated with the target question; processing the target question and the target image by using a multimodal model to obtain an output of the multimodal model, the output including a text portion and at least one segmentation codebook for the target image, and the at least one segmentation codebook indicating feature information of at least one object related to the target question at a plurality of scales of the target image, respectively; decoding the at least one segmentation codebook based on the target image respectively by using an image decoder model to obtain at least one segmentation mask, the at least one segmentation mask indicating a region where the at least one object is located in the target image; and determining an answer to the target question based on the text portion and the at least one segmentation mask.

In a second aspect of the present disclosure, there is provided an apparatus for multimodal data processing. The apparatus includes: an obtaining module configured to obtain a target question and a target image associated with the target question; a multimodal module configured to process the target question and the target image by using a multimodal model to obtain an output of the multimodal model, the output including a text portion and at least one segmentation codebook for the target image, and the at least one segmentation codebook indicating feature information of at least one object related to the target question at a plurality of scales of the target image, respectively; a decoding module configured to decode the at least one segmentation codebook based on the target image respectively by using an image decoder model to obtain at least one segmentation mask, the at least one segmentation mask indicating a region where the at least one object is located in the target image; and an answer determining module configured to determine an answer to the target question based on the text portion and the at least one segmentation mask.

In a third aspect of the present disclosure, there is provided an electronic device, the device including at least one processing unit; and at least one memory, the at least one memory being coupled to the at least one processing unit and storing instructions for execution by the at least one processing unit, the instructions, when executed by the at least one processing unit, cause the apparatus to perform a method of the first aspect.

In a fourth aspect of the disclosure, there is provided a computer readable storage medium having stored thereon a computer program, the computer program, when executed by a processor, implements the method of the first aspect.

It should be appreciated that what is described in this Summary is not intended to limit critical features or essential features of embodiments of the disclosure, nor is it intended to limit the scope of the disclosure. Other features of the present disclosure will be readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example data processing environment in which embodiments of the present disclosure can be implemented;

FIG. 2 illustrates a schematic diagram of a model training and application environment in which embodiments of the present disclosure can be implemented;

FIG. 3 illustrates a schematic diagram of an example architecture of a cross-modal data processing system according to some embodiments of the present disclosure;

FIG. 4 illustrates a schematic diagram of an example architecture of an image decoder model according to some embodiments of the disclosure;

FIG. 5 illustrates a schematic diagram of a decoding effect with and without feature code fusing according to some embodiments of the disclosure;

FIG. 6 illustrates a schematic diagram of prompt input according to some embodiments of the present disclosure;

FIG. 7 illustrates a flowchart of a process for multimodal data processing according to some embodiments of the disclosure;

FIG. 8 illustrates a block diagram of an apparatus for multimodal data processing according to some embodiments of the disclosure; and

FIG. 9 illustrates an electronic device in which one or more embodiments of the present disclosure may be implemented.

### DETAILED DESCRIPTION

The following will describe the implementations of the present disclosure in more detail with reference to the accompanying drawings. Although some implementations of the present disclosure are shown in the drawings, it should be understood that the present disclosure can be implemented in various forms and should not be construed as limited to the implementations set forth herein. On the contrary, these implementations are provided for a more thorough and complete understanding of the present disclosure. It should be understood that the drawings and implementations of the present disclosure are provided for illustrative purposes only and are not intended to limit the scope of protection of the present disclosure.

In the description of the implementations of the present disclosure, the term “including” and the like should be understood as non-exclusive inclusion, that is, “including but not limited to”. The term “based on” should be understood as “based at least in part on.” The term “one implementation” or “the implementation” should be understood as “at least one implementation”. The term “some implementations” should be understood as “at least some implementations”. Other explicit and implicit definitions may also be included below. As used herein, the term “model” may denote a degree of match between respective data. The degree of match may be obtained, for example, based on a variety of technical solutions that are currently known and/or will be developed in the future.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, prompt information is sent to the user to explicitly prompt the user that an operation requested by the user will require obtaining and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

As used herein, the term “model” may learn the degree of match between corresponding inputs and outputs from training data, so that after the training is complete, a corresponding output may be generated for a given input. The generation of the model may be based on a machine learning technology. Depth learning is a machine learning algorithm that processes inputs and provides corresponding outputs by using a multi-tiered processing unit. A neural network model is one example of a model based on deep learning. Herein, “model” may also be referred to as “machine learning model,” “learning model,” “machine learning network,” or “learning network”, which may be used interchangeably herein.

A “neural network” is a machine learning network based on depth learning. A neural network is capable of processing inputs and providing corresponding outputs, which typically include an input layer and an output layer and one or more hidden layers between the input layer and the output layer. Generally, a neural network used in a deep learning application includes a lot of hidden layers, thereby increasing the depth of the network. The various layers of the neural network are connected in sequence such that the output of a previous layer is provided as the input of a subsequent layer, wherein the input layer receives the input of the neural network and the output of the output layer is provided as the final output of the neural network. Each layer of the neural network includes one or more nodes (also referred to as processing nodes or neurons), and each node processes the input from a previous layer.

Generally, machine learning may roughly include three phases, namely a training phase, a testing phase, and an application phase (also referred to as an inference phase). In the training phase, a given model may be trained by using a large amount of training data, constantly and iteratively updating parameter values until the model obtains consistent reasoning that meets expected goals from the training data. By training, the model may be considered as being able to learn an association between input and output from training data (also referred to as mappings of input to output). A parameter value of the trained model is determined. In the testing stage, a test input is applied to the trained model, so as to test whether the model can provide a correct output, thereby determining the performance of the model. In the application phase, the model may be configured to process actual input based on the trained parameter value to determine corresponding output.

Multimodal large language models (MLLMs) are good at processing tasks which requires comprehension and synthesis across different modalities. Two types of methods are mainly used to implement this model, i. e. a method based on structural design and a method based on a pre-training paradigm. The first method based on structure design adopts a conventional multimodal pre-training technology, and uses a multimodal data set to train a multimodal model from the beginning. This strategy requires a large amount of resources, including computational power and extensive data sets, to achieve competitive performance. The second method based on a pre-training paradigm builds a stream on a pre-trained text LLM, and enhances multimodal comprehension and generation capabilities through instruction-based optimization. Due to the rapid development of LLMs and reasonable training requirements, this framework is used by more and more researchers to develop multimodal methods. Some research proposes combining adaptors to coordinate the visual and textual representation of the LLMs. However, they only process image and textual input to generate textual output. This inherent limitation limits their applicability in region-specific comprehension tasks.

Pixel-level comprehension is a basic task of the MLLM. In order to enhance interaction between a segmentation model and a human, researchers explore a multimodal method, which integrates point, frame and text prompts into the segmentation model. However, the limited capabilities of the prompt encoders restricts their ability in processing multimodal input.

Alternatively, researchers focus on providing LLM with multimodal pixel understanding ability. Border box coordinates can be converted into text labels, and object locations can be generated through label classification. This approach may be extended to broader visual and linguistic tasks, enhancing the adaptability of tag-based object representations. Applying label classification in the LLM enhances the effectiveness of the method. In addition, in order to enhance generation of a pixel comprehension output and reduce the length of label generation, region-level prediction can be generated in combination with a special decoder design.

However, the existing models primarily rely on explicit human instructions to identify a particular object or class and then perform visual recognition tasks. Such reliance impairs their ability to autonomously inferentiate and understand the user intention. Additionally, it is currently limited to processing only a single target in an image.

Based on a large-scale language model (LLM), the large-scale multimodal model (LMM) significantly enhances high-level visual perception and user interaction experience. However, most LMMs mainly generate a textual description of a global image or region with limited ability to respond to pixel-level, such as an object mask. It limits practical applications of multimodal systems in fine-grained comprehension tasks, such as image editing, autopilot, and robotics, among others.

The use of LLMs to generate object masks in inference-segmentation tasks has been proposed, which is more challenging and flexible for real-world applications. Compared to traditional segmentation for explicitly specified objects (e. g., “orange”), inference segmentation requires complex inference for more complex instructions (e. g., “Vitamin C-rich fruit”). It is required that complex inference mask is aligned well with the capabilities of the LMM, which is a challenge for traditional models, especially when multiple target objects in a real scene are involved.

The current LMM mainly has the following two problems. The first problem is that it relies on a pre-trained image segmentation model. This not only incurs a large amount of computation cost, but also limits the performance within a performance range of the pre-trained model, thereby preventing the model from benefiting from further training extensions. The second problem is the inability to deal with inference tasks involving multiple target objects, which is very common in real-world scenarios.

Embodiments of the present disclosure provide a multimodal data processing solution. In the solution, a multimodal model is used to process a target problem and a target image, to obtain an output of the multimodal model. The output includes a text portion and at least one segmentation codebook for the target image. The segmentation codebook indicates feature information of at least one object related to the target question at a plurality of scales (for example, visual scales) of the target image. By using an image decoder model to respectively decode at least one segmentation codebook based on a target image, at least one corresponding segmentation mask is obtained. At least one segmentation mask indicates a region in which the corresponding object is located in the target image. An answer to the target question is determined based on the text portion and the at least one segmentation mask.

The solution proposed by the present disclosure effectively integrates a multi-objective inference segmentation capability into a multimodal model. Thus, tasks with any number of open targets and diverse inference complexity can be processed, while additional costly segmentation models are avoided, thereby improving efficiency and being applicable to various application scenarios. In this way, advanced visual perception and user interaction experience are significantly improved.

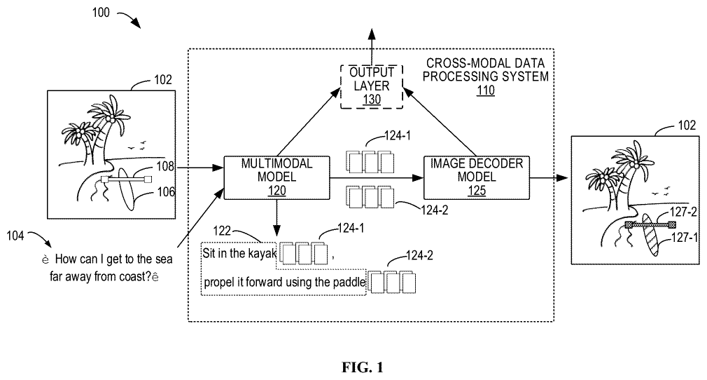

FIG. 1 illustrates a schematic diagram of an example data processing environment 100 in which embodiments of the present disclosure can be implemented. In the environment 100 of FIG. 1, a cross-modal data processing system 110 is provided to process pairs of images 102 and text 104. Here, the image 102 may include a dynamic image or a still image. A dynamic image is, for example, a video where individual video frames in the video may be considered to be a single image. A still image is a single image.

In many application scenarios, image modal and text modal data need to be processed. For example, some application scenarios involve image and text matching tasks. Such tasks include retrieving images from text, retrieving text from images, video/image question-answering (finding answers to questions from videos or images), and so forth. In order to achieve a task involving multimodal data, a multimodal model 120 may be provided, depending on machine learning techniques. The multimodal model can be implemented by using the LLM and LMM models. In question-answering tasks, the text 104 represents a target question and the image 102 represents a target image of an answer to a target question to be found. The multimodal model 120 is configured to obtain a text portion 122 and one or more segmentation codebooks 124 based on the image 102 and the text 104. The text portion 122 may represent a text portion of an answer to the question. The one or more segmentation codebooks indicate feature information of one or more objects associated with the text 104 at multiple scales of the image 102. The feature may be a vector with a specific dimension, also referred to as a feature representation, a feature vector, a feature code, etc., and these terms are used interchangeably herein. Features can characterize corresponding data in a particular dimensional space.

The segmentation codebook obtained from the multimodal model 120 is provided to image decoder model 125. The image decoder model 125 is configured to decode the segmentation codebook based on the image 102, so as to obtain a corresponding segmentation mask. The segmentation mask indicates a region 127 where the corresponding object associated with the text 104 is located in the image 102.

Depending on the specific task, the outputs of the multimodal model 120 and the image decoder model 125 are provided to the output layer 130 for determining the task output. In question-answering tasks, the output layer 130 is configured to determine the answer to the question represented by the text 104 based on the text portion of the answer to the question obtained from the multimodal model 120 and the segmentation mask obtained from the image decoder model 125.

For example, in the example of FIG. 1, the text 104 is an English sentence ‘How can I get to the sea far away from coast?’, the image 102 presents a kayak 106 parked on a beach with a paddle 108 thereon. The text portion 122 output by the multimodal model 120 is an English sentence “Sit in the kayak, propel it forward using the paddle”. The multimodal model 120 also outputs segmentation codebooks 124-1 and 124-2 (individually or collectively referred to as segmentation codebooks 124) corresponding to different objects (e. g., including the kayak 106 and the paddle 108) related to the text portion 122. The image decoder model 125 decodes the segmentation codebooks 124-1 and 124-2 to obtain regions 127-1 and 127-2 where corresponding objects are located in the image 102.

It should be understood that the example images and text in FIG. 1 are given for illustrative purposes only and the scope of embodiments of the present disclosure should not be limited to any particular form of text and image. It should also be understood that the question in text form is merely an example but not a limitation. The question may also be input in other ways, such as by speech or gestures.

In some embodiments, the training processes of the multimodal model 120 and the image decoder model 125 may include a pre-training process and a fine-adjustment process. Large-scale pre-trained models typically have strong generalization capabilities and efficient utilization of large-scale data. After a model is pre-trained on large-scale data, a small amount of data can be used to finely adjust the pre-trained model based on specific requirements of different downstream tasks, so that the overall model learning efficiency can be significantly improved and the need for labelling data of specific downstream tasks can be reduced. The multimodal model 120 and image decoder model 125 that completes training may be provided for use in a particular application scenario.

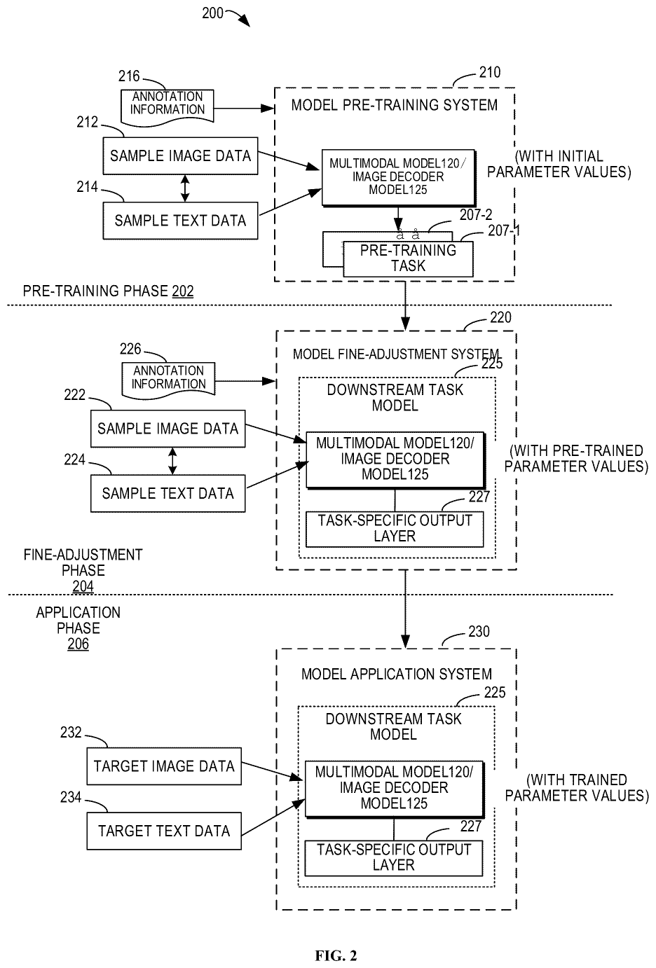

FIG. 2 illustrates a schematic diagram of a model training and application environment 200 in which embodiments of the present disclosure can be implemented. Three different phases for the model are shown in the environment 200 of FIG. 2, including a pre-training phase 202, a fine-adjustment phase 204, and an application phase 206. After the pre-training or fine-adjustment phase is completed, there may also be a testing phase, which is not shown in the drawings.

In the pre-training phase 202, the model pre-training system 210 is configured to pre-train the multimodal model 120. At the beginning of pre-training, the multimodal model 120 may have initial parameter values. The pre-training process is to update the parameter values of the multimodal model 120 and the image decoder model 125 to desired values based on the training data.

The training data used by the pre-training includes a sample image 212 and sample text 214, and it may also include annotation information 216. The annotation information 216 may include a sample answer and a true value segmentation mask for the sample image, and the true value segmentation mask indicates a region in which the respective sample object is located in the sample image 212.

While a pair of sample image and text is shown, in the pre-training phase, a large number of sample images and text may be used to train. During the pre-training process, one or more pre-training tasks 207-1, 207-2, etc. may be designed. The pre-training tasks are used to assist in parameter updating of the multimodal model 120 and the image decoder model 125. Some pre-training tasks may perform parameter updates based on the annotation information 216.

In the pre-training phase 202, the multimodal model 120 and the image decoder model 125 may be obtain a powerful generalization capability by learning based on a large amount of training data. After the pre-training is completed, the parameter values of the multimodal model 120 and the image decoder model 125 have been updated, with the pre-trained parameter values. The pre-trained multimodal model 120 may more accurately generate a text portion of answers to questions and a segmentation codebook of a relevant object in the image. The pre-trained image decoder model 125 may more accurately generate a segmentation mask for the relevant object in the image to indicate the region where the related object is located in the image.

The pre-trained multimodal model 120 and the image decoder model 125 can be provided to a fine-adjustment phase 204 for fine tuning various downstream tasks by the model fine-adjustment system 220. In some embodiments, depending on the downstream task, the pre-trained multimodal model 120 and the image decoder model 125 may be connected to a corresponding task-specific output layer 227, thereby constructing the downstream task model 225. This is because the required outputs may be different for different downstream tasks.

During the fine-adjustment phase 204, the training data continues to be used to adjust the parameter values of the multimodal model 120 and the image decoder model 125. The parameters of the task feature output layer 227 may also be adjusted, if desired. The training data used in the fine-adjustment phase includes the sample image 222 and sample text 224, and may also include annotation information 226. Although a pair of sample images and text is shown, a certain amount of sample images and text for training may be used for training in the fine-adjustment phase.

A corresponding training algorithm is also utilized to update and adjust the parameters of the overall model when performing fine-adjustment. Since the multimodal model 120 and the image decoder model 125 have learned much knowledge from the training data in the pre-training phase, an expected downstream task model may be obtained with a small amount of training data in the fine-adjustment phase 204.

In some embodiments, during the pre-training phase 202, one or more task-specific output layers may be constructed for pre-training the multimodal model 120 and the image decoder model 125 under multiple downstream tasks, according to the objective of the pre-training task. In this case, if a task-specific output layer used in a downstream task is the same as a task-specific output layer constructed in the pre-training, the pre-trained multimodal model 120 and the image decoder model 125 and the task-specific output layer may be directly used to form a corresponding downstream task model. In this case, the downstream task model may not require fine-adjustment, or require only fine-adjustment with a small amount of training data.

In the application phase 206, the obtained downstream task model 225, having trained parameter values, may be provided to the model application system 230 for use. In the application phase 206, corresponding inputs in the actual scene can be processed by using the downstream task model 225 and corresponding outputs is provided. For example, the outputs of the multimodal model 120 and the image decoder model 125 in the downstream task model 225 are provided to the task feature output layer 227 to determine the output of the corresponding task. The output may be summarized as an answer to the question represented by the target text 234 determined in the target image 232.

In FIGS. 1 and 2, the cross-modal data processing system 110, the model pre-training system 210, the model fine-adjustment system 220, and the model application system 230 may include any computing system having computing capabilities, such as a variety of computing devices/systems, terminal devices, servers, etc. The terminal device may relate to any type of mobile terminal, fixed terminal, or portable terminal, including a mobile phone, a desktop computer, a laptop computer, a notebook computer, a netbook computer, a tablet computer, a media computer, a multimedia tablet, or any combination of the foregoing, including accessories and peripherals of these devices, or any combination thereof. The servers include, but are not limited to, mainframes, edge compute nodes, compute devices in a cloud environment, and the like.

It should be appreciated that the components and arrangements of environment 100 and environment 200 illustrated in FIGS. 1 and 2 are merely examples and a computing system suitable for implementing the exemplary implementations described herein may include one or more different components, other components, and/or different arrangements. For example, while shown as being separate, the model pre-training system 210, the model fine-adjustment system 220, and the model application system 230 may be integrated in the same system or device. The implementations of the present disclosure are not limited in this regard.

In some embodiments, the training phase of the multimodal model 120 and the image decoder model 125 may not be divided into the pre-training phase and the fine-adjustment phase as shown in FIG. 2, but instead the downstream task models may be constructed directly on a task basis and trained using large amount of training data.

Some example environments for feature extraction of image and text modalities are discussed above. To process data of different modalities, the architecture of the cross-modal data processing system 110 needs to be specially designed. There are some solutions that present an example architecture for a cross-modal data processing system 110.

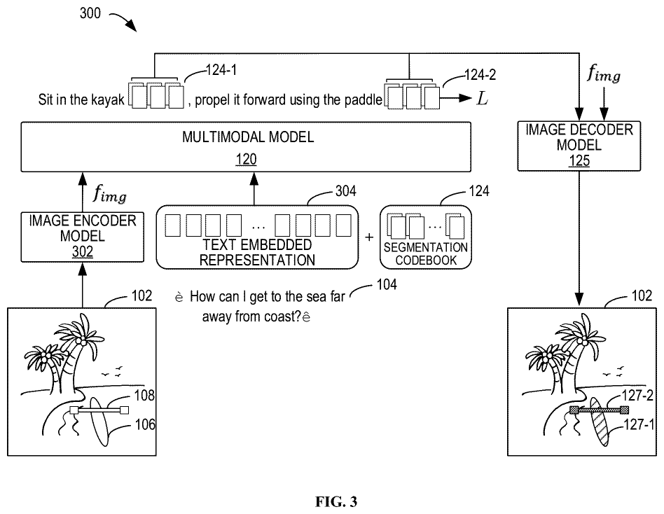

FIG. 3 illustrates a schematic view of an example architecture 300 for a cross-modal data processing system 110 according to some embodiments of the present disclosure. For illustrative purposes only, it is still assumed that the image 102 and the text 104 shown in FIG. 1 are to be processed across the modal data processing system 110. As may be understood in connection with the example environment of FIG. 2, the images and text input to multimodal model 120 may differ at different phases of pre-training, fine-adjustment, and application. In some embodiments, the training phases of the multimodal model 120 and the image decoder model 125 may be integrated without being divided into the pre-training and fine-adjustment phases shown in FIG. 2.

As shown in FIG. 3, the cross-modal data processing system 110 obtains a target question (e. g., text 104) and a target image (e. g., image 102) associated with the target question. The multimodal model 120 is utilized to process target question and target image, so as to obtain an output of the multimodal model 120. In some embodiments, the cross-modal data processing system 110 may include an image encoder model 302 configured to extract a plurality of image features at a plurality of scales from the target image, and the image features are provided to a multimodal model 120. A scale may include a visual scale, which, e. g., indicates various graininess or scales of a visual concept.

In some embodiments, the embedded representation 304 corresponding to the target question may be provided to the multimodal model 120. In some other embodiments, the target question itself may be input directly into the multimodal model 120.

The output of the multimodal model 120 includes a text portion 122 and segmentation codebooks 124-1 and 124-2 for the target image. Segmentation codebooks 124-1 and 124-2 indicate feature information of related objects 106 and 108 in the target image. In some embodiments, in order to enrich encoding of target-specific information to improve the quality of masks subsequently generated by image decoder model 125, an overall segmentation codebook including multiple sets of feature codes (also referred to as “labels”) may be used. Each label group corresponds to a different scale, e. g. a different graininess or scale reflecting the visual concept. Efficient segmentation requires understanding of semantic categories and complex geometries. Thus, information related to heterogeneous visual elements can be incorporated.

By way of example, each segmentation codebook C_{seg} may include a plurality of label groups, each including one or more labels, corresponding to semantic metrics of visual features from the image encoder model 302. C_{seg} may be defined as follows:

$${C}_{seq} = {\{ {c}_{n}^{l} ∈ {ℝ}^{d} \}}_{n = 1 , l = 1}^{N , L} \qquad ( 1 )$$

wherein Cₙ^{l} denotes a label; L and N respectively denote a visual scale per label group and the number of labels, and the value thereof can be set according to practical requirements; d denotes the hidden dimension in the multimodal model 120. For ease of discussion, the following uses N=1 as an example to describe how to integrate the codebook label into the multimodal model 120 to encode required information for generating the target mask.

In some embodiments, the image encoder module 302 may be implemented based on a pre-trained (CLIP) model for comparing text-to-image pairs. For the input image X_{img}, the image encoder module 302 (denoted as [symbol] ) extracts a set of multi-scale visual features I_{img}={I_{img}^{l}} [symbol] from [symbol] (x_{img}), including L visual features corresponding to the selection layer of [symbol] . The output of the last layer I_{img}^{L} encapsulates the global image information, and is converted into a language space through a vision-to-language projection layer Pv→T. At the same time, the vision-to-decoder projection Pv→D converts all of the I_{img} features, resulting in:

$${f}_{imh} = {\{ {f}_{img}^{ℓ} \}}_{ℓ = 1}^{L} \qquad ( 2 )$$

$$wherein :$$

$${f}_{img}^{ℓ} = {p}_{V \to D} ( {I}_{img}^{ℓ} ) \qquad ( 3 )$$

The codebook label is processed together with the input image 102 and text 104 by the multimodal model 120 to generate an interlaced response Yᵣₑₛ in an autoregressive manner:

$${y}_{res} = ℱ ( {p}_{V \to T} ( {I}_{img}^{L} ) , {x}_{txt} , {C}_{eg} ) \qquad ( 4 )$$

To help understanding this process, considering the example of a text query “segment the left apple” Then, output Yᵣₑₛ contains L labels of C_{seg}: “apples are c¹, . . . , c^{L}”.

The segmentation codebook output by the multimodal model 120 is provided to the image decoder model 125. The segmentation codebook is decoded by the image decoder model 125 based on the target image to obtain the corresponding segmentation mask. The segmentation mask indicates the region where the object of interest is located in the target image. In some embodiments, a plurality of image features generated by the image encoder model 302 may be provided to the image decoder model 125. With these image features, the image decoder module 125 decodes the segmentation codebook into segmentation masks.

For example, the hidden embedded representation of the segmentation code book C_{seg} (i. e., the output of the last layer of [symbol] in equation (4)) is represented as:

$${h}_{eg} = {\{ {h}_{seg}^{ℓ} \}}_{ℓ = 1}^{L} \qquad ( 5 )$$

This hidden embedded representation can be used as an input to the image decoder model 125, along with f_{img}, for generation of segmentation mask.

Thus, the image decoder model 125 (denoted as [symbol] ) may be implemented as a lightweight pixel decoder that may utilize multi-scale features from the image encoder model 302. The task of the image decoder model 125 is to learn these features and the hidden embedding to segmentation mask conversion from the label group C_{seg}. Such a design does not require an additional expensive segmentation model, thereby significantly improving efficiency.

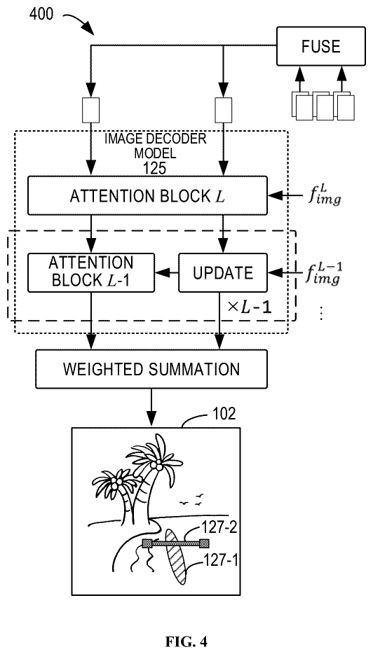

An example process for the image decoder module 125 to generate a segmentation mask will be discussed below in connection with FIG. 4.

FIG. 4 illustrates a schematic diagram of an example architecture 400 of an image decoder model 125 according to some embodiments of the disclosure.

As shown in FIG. 4, in architecture 400, the image decoder model 125 includes L attention blocks {Att [symbol] , each corresponding to image features of a different scale and a corresponding segmentation codebook.

In some embodiments, for one of the at least one segmentation codebooks (referred to as a “first segmentation codebook”), a plurality of mask maps for one object (referred to as ‘a first object’) in the target image at a plurality of scales are determined respectively, based on a plurality of image features of the target image at a plurality of scales and a plurality of feature information portions at a plurality of scales in the first segmentation codebook (for example, the hidden embedded representation in equation (5)). A corresponding segmentation mask (referred to as “first segmentation mask map”) is determined by merging a plurality of mask maps, the first segmentation mask map indicating a region in which the first object is located in the target image.

For example, for generation of each target mask, [symbol] generates mask maps [symbol] (also referred to as mask score maps) sequentially on each scale. For example, for a certain target mask, a corresponding mask map is generated based on image features at each scale and corresponding label groups in the segmentation codebook. After the mask maps corresponding to the image features of different scales and the label groups are merged, a segmentation mask map of the target mask is generated to indicate a region where the corresponding object is located in the target image.

In some embodiments, a first mask map for a first object at a first scale is determined based on an image feature (referred to as “a first image feature”) in the plurality of image features at one scale of the plurality of scales (referred to as “a first scale”), and feature information portions (referred to as “first feature information portion”, for example, indicated by the hidden embedded representation in Equation (5)) of the first segmentation codebook on the first scale of the plurality of scales. The updated second image feature may be obtained by updating, using the first mask map, an image feature (referred to as “a second image feature”) in the plurality of image features at another scale (referred to as “second scale”) of the plurality of scales. A second mask map for the first object at the second scale is determined based on the updated second image feature and a feature information part (referred to as a “second feature information portion”) at a second scale of the plurality of scales in the first segmentation code book.

For example, after a mask map at scale [symbol] is generated, attention for the image decoder model 125 may be directed to regions with higher correlation at the subsequent scale [symbol] −1. Thus, the image decoder model 125 can be directed to focus regions where confidence scores are high, which further improves the accuracy of mask generation.

By way of example, image features and mask maps at different scales may be adjusted by the following equation (6):

$$\begin{matrix}{f}_{img}^{{l}^{′}} = \{ \begin{matrix}{f}_{img}^{L} & l = L \\ {f}_{img}^{l} ⊙ ( σ ( {m}^{l + 1} ) + 1 ) & l < L\end{matrix} \\ {m}^{l} = {Attn}^{l} ( {h}^{l} , {f}_{img}^{{l}^{′}} ) .\end{matrix} \qquad ( 6 )$$

where ƒ_{img}^{l′} represents an adjusted feature at scale [symbol] , σ represents a sigmoid function, ⊙ represents multiplication by element, and h^{l} represents a hidden embedded representation of the segmentation code book at scale [symbol] (which indicates a feature information portion of the segmentation code book at scale [symbol] ).

In some embodiments, mask maps at different scales may be merged through a weighting process. The following weighting factors may be learned:

$$γ = {\{ {γ}^{ℓ} \}}_{ℓ = 1}^{L} \qquad ( 7 )$$

The mask maps at all scales are combined to obtain the final segmentation result:

$$\hat{M} = {\sum }_{ℓ = 1}^{L} {γ}^{ℓ} {m}^{ℓ} 8 \qquad ( 8 )$$

where |γ|=1.

The above are described by taking N=1 as an example, where N represents the number of labels in each label group. That is, a single feature code (i. e., label) is used at each scale to encode the required context and knowledge for target resolution. To further enhance the inference ability of models in complex inferencing scenarios (e. g., scenarios with multiple objects or intrinsic complexity), in some embodiments, a segmentation code book may include multiple feature codes (i. e., labels) at each of the plurality of scales. Each feature code may correspond to one scale. Thus, a plurality of labels may be used at each scale [symbol] , i. e.:

$${C}^{ℓ} = {\{ {C}_{n}^{ℓ} \}}_{n = 1}^{N} \qquad ( 9 )$$

For a plurality of scales in a segmentation codebook (for example, a first segmentation codebook), corresponding feature codes at each scale may be fused respectively to obtain a plurality of feature information portions of the segmentation codebook at the plurality of scales. This manner is also referred to as feature code integration.

For example, before the image decoder model 125 performs decoding, a linear projection layer may be used to convert a hidden state of a grouped label into:

$${h}^{l} = ϕ ( {h}_{1}^{l} , … , {h}_{N}^{l} ) \qquad ( 10 )$$

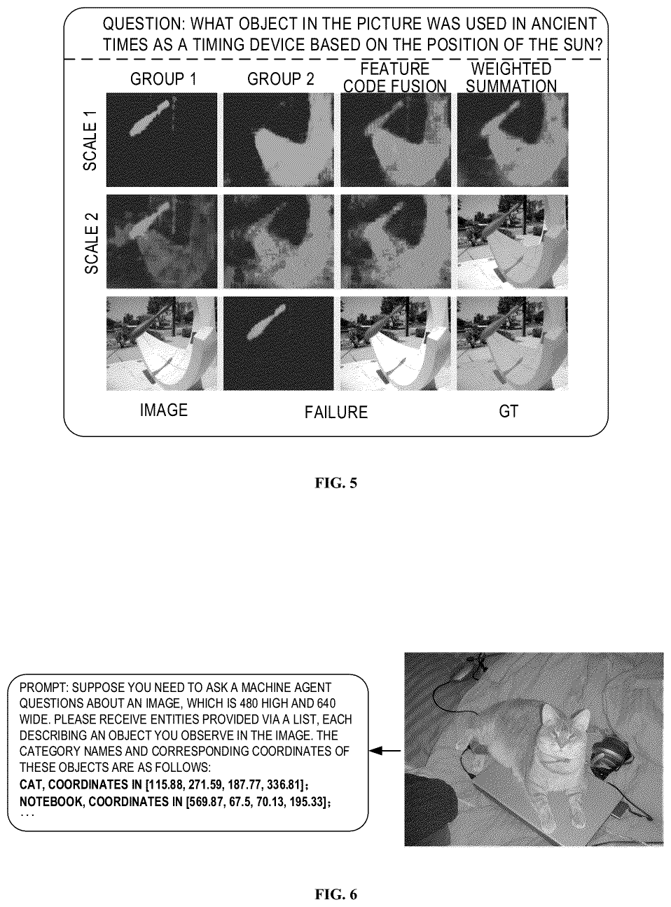

FIG. 5 illustrates a schematic view of a decoding effect with and without feature code merging according to some embodiments of the disclosure. In FIG. 5, the first two rows show a multi-scale feature code fusion mechanism, and the last row shows a failure situation due to using only one feature code. In a scheme employing the feature code fusion mechanism, segmentation codebooks at two scales are used and each scale has two feature codes. Where each label group includes multiple labels, the visualization of the decoder after each attention map shows that different labels generate complementary information, which further enhance the accuracy of segmentation mask generation as compared to a single label setting.

After at least one segmentation mask is obtained, an answer to the target question may be determined based on the text portion 122 and the segmentation mask output by the multimodal model 120.

For example, the following example process may be employed to determine an answer to a target question. 1) Visual feature extraction: extracting features at multiple scales from an input image using the image encoder model 302; 2) converting the visual features into dimensions that are acceptable for the multimodal model 120 and the image decoder model 125; 3) transferring the visual features, text features, and multi-scale segmentation codebooks into the multimodal model 120 to achieve multimodal inference; 4) the output features of the image encoder model 302 and the plurality of segmentation feature codes (or labels) output by the multi-mode model 120 are transferred to the image decoder model 125 to generate target segmentation mask maps corresponding to features at different levels; 5) finally fusing the segmentation results of different scales.

In some embodiments, at least a portion of the image decoder model 125 and the multimodal model 120 are trainable. For example, the trainable portion includes the image decoder model 125, some parameters in the multimodal model 120 (e. g., low order adaptation (LoRA) parameters), the segmentation code book C_{seg}, the visual-to-language and visual-to-decoder projection layers PV→T and PV→D, etc.

The trainable portion may be trained based on a training dataset. The trainable data set may include a sample question, a sample image, a sample answer, and a plurality of true value segmentation masks for the sample image. The plurality of true value segmentation masks respectively indicate regions in which the plurality of sample objects are located in the sample image.

In existing public datasets, the details and objects in the segmentation mask represent inadequate and lack of question-answer pairs capable of characterizing complex inference and variable number of target objects. In order to be able to further process tasks involving any number of objects that may be openly set, as well as diversifying inference complexity, in some embodiments, existing training datasets are expanded, for example, multi-objective inference segmentation (MUSE) data. The MUSE data may have open-set concepts, detailed object descriptions, complex multi-objective question-answer pairs, and instance-level mask annotations. Thus, the training efficiency is further improved.

By way of example, the MUSE data set may be constructed on the basis of public data sets. Some data sets use an unambiguous target object name, e. g., “orange”, to guide segmentation, but lack more complex instructions, e. g., “Vitamin C-rich fruit”. Moreover, these datasets also fail to provide multi-objective question-answer pairs, and the objective description is directly connected to the segmentation mask. However, multi-objective question-answer pair is a common requirement in realistic scenes. For example, the question of “Vitamin C-rich fruit” may be “how to make the fruit salad?” Multiple instances of segmentation masks and detailed text descriptions based on image content can be selected from publicly available datasets. With these examples, question-answer pairs can be constructed.

In some embodiments, a data set may be constructed using a model. For example, an image title may be generated by the model, and questions about multiple image regions may be generated. An image with pre-existing mask annotations may be utilized to reduce annotation costs. Image titles, manually selected object names, and bounding box coordinates in the image may be entered into the model to facilitate answer selection and question formulation.

In order to avoid limiting the content of the generated question-answer pairs to the description of the title due to the inability to directly perceive the content of the image and accordingly limiting the data diversity, a dynamic answer generation method may be used. In some embodiments, the diversity of the generated question-answer pairs may be increased by means of the prompt word input.

For example, location information of a region where each of the plurality of sample objects is located in the sample image may be determined based on the plurality of true value segmentation masks of the sample image. The prompt word input may be determined based on the sample image and the respective pieces of location information of the plurality of sample objects. The prompt word input is used for guiding generation of a question and an answer for a sample image. The prompt word input may be provided for a further trained multimodal model, so as to obtain a sample question and a sample answer output by the further multimodal model. The sample answer includes an indication of one or more of the plurality of sample objects. In some embodiments, the prompt word input may also be used to direct the further multimodal model to generate questions and answers relating to at least two objects.

FIG. 6 shows a schematic diagram of a prompt word input according to some embodiments of the present disclosure. As shown in FIG. 6, all object instance class names and corresponding bounding box coordinates in an image may be provided to a model to generate a prompt word input. Using the prompt word input, the model may construct a question-and-answer pair related to the image content based on the autonomously selected object instances.

In some embodiments, the trainable portion may be trained according to a predetermined loss function. The predetermined loss function may be based on one or more loss values. As the number of objects increases, the likelihood of the multimodal model 120 and the image decoder model 125 encountering confusion and generating overlapping masks may increase. In some embodiments, the multimodal model 120 and the image decoder model 125 in training may be utilized during training to determine a plurality of predictive segmentation masks for a sample image. Each prediction segmentation mask corresponds to an object of one prediction. A weighted graph corresponding to a sample image may be determined based on a plurality of predictive segmentation masks. In the weighted graph, a weighted value corresponding to a region in the sample image including at least two objects among the plurality of sample objects is greater than a weighted value corresponding to a region in the sample image including a single sample object or not including a sample object. A loss value (also referred to as a “first loss value”) is determined by respectively weighting a plurality of difference masks between the plurality of predictive segmentation masks and the plurality of true value segmentation masks using the weighted graphs.

By using the first loss value, a plurality of objects can be predicted together, which helps the multimodal model 120 and the image decoder model 125 clearly identify and learn different objects, thereby further improving the training efficiency. Such losses are also referred to as target refinement losses.

By way of example, the predictive segmentation mask may be represented as:

$${\{ {\hat{M}}_{k} ∈ {ℝ}^{H \times W} \}}_{k = 1}^{K} \qquad ( 11 )$$

where K denotes the total number of objects, H and W denote the morphology of the mask, and \hat{M}ₖ [symbol] ∈ [symbol] denotes a binary value of each pixel. The following mapping A is used to assign increasing weights to regions predicted to have multiple objects:

$${A}_{i} = \{ \begin{matrix}α , & {\sum }_{k} {\hat{M}}_{{k}_{i}} \geq 2 \\ 1 , & {\sum }_{k} {\hat{M}}_{{k}_{i}} < 2\end{matrix} \qquad ( 12 )$$

where α is a hyperparameter. The weighted loss (i. e., object refinement loss) can be calculated from the true Mₖ for each mask as follows:

$${ℒ}_{ref} = \frac{1}{KHW} {\sum }_{k} {\sum }_{i} {A}_{i} {ℒ}_{BCE} ( {\hat{M}}_{{k}_{i}} , {\hat{M}}_{{k}_{i}} ) \qquad ( 13 )$$

where [symbol] _{BCE} denotes the binary cross-entropy loss per pixel.

As an example, the following overall loss function may be employed for end-to-end training:

$$ℒ = {ℒ}_{txt} + {λ}_{ref} {ℒ}_{ref} + {λ}_{dice} {ℒ}_{dice} \qquad ( 14 )$$

where [symbol] ₜₓₜ denotes autoregressive cross-entropy loss for text generation; and [symbol] _{dice} denotes DICE loss for mask generation along with object refinement loss [symbol] _{ref}. The overall objective [symbol] constitutes a weighted sum of these losses [symbol] ₜₓₜ, [symbol] _{dice}, and [symbol] _{ref}, which is calibrated by λ_{ref} and λ_{dice}.

In various benchmarking tests, the multimodal data processing scheme in accordance with embodiments of the present disclosure achieved good results. In testing, evaluations were performed on three benchmarks: MUSE, multi-reference segmentation, and traditional reference segmentation. The first two benchmarks relate to a plurality of objects, and the last focus on a single object.

For the MUSE benchmark, the following was focused on: 1) a natural text description that is aligned with the object mask is generated; 2) the accuracy of the match between the object mask and the text description; and 3), the quality of the mask. The evaluation process of each question may include four steps as follows. First, by using a binary match, a predicted mask and a truth mask are matched based on intersection and union (IoU) scores. Any unassigned predicted or true value is assigned with an empty mask. For example, as shown in FIG. 2, the text might write as follows: “Sitting in a kayak (a red kayak parked on the beach) and using a paddle (a two-bladed paddle on a kayak) to propel it forward”. The content in parentheses is a true value description. Again, each prediction scores from 1 to 10, with a higher score indicating better quality. Finally, the generalized intersection and union ratio (gIoU) and complete intersection and union ratio (cIoU) metrics for each prediction are calculated.

Table 1 shows a comparison of the method according to the present disclosure with other methods with respect to the MUSE baseline, where PixelLM represents the method of the present disclosure, † indicates that the feature code fusion mechanism and object refinement penalty are not employed.

TABLE 1

| | | | | | Test | | | | | |
|---|---|---|---|---|---|---|---|---|---|---|
| | | | Val | | few | | many | | | |
| | w/o | | overall | | targets | | targets | | overall | |
| | SAM | TFLOPs | gIoU | cIoU | gIoU | cIoU | gIoU | cIoU | gIoU | cIoU |
| SEEM | ✓ | [symbol] | [symbol] | [symbol] | [symbol] | [symbol] | [symbol] | [symbol] | [symbol] | [symbol] |
| LISA-7B | x | 7.16 | 18.8 | 29.0 | 24.7 | 36.5 | 9.6 | 24.5 | 12.8 | 27.1 |
| LISA-7B_{rec} | x | 7.16 | 24.5 | 31.1 | 30.0 | 30.9 | 12.4 | 23.2 | 16.2 | 24.8 |
| LISA-7B_{aug} | x | 7.16 | 42.0 | 46.1 | 43.5 | 52.0 | 37.7 | 42.3 | 38.9 | 44.4 |
| PixelLM-7B^{†} | ✓ | 3.57 | 39.9 | 48.0 | 43.1 | 56.7 | 36.0 | 38.2 | 37.5 | 42.2 |
| PixelLM-7B | ✓ | 3.57 | 42.6 | 50.7 | 44.6 | 59.2 | 37.7 | 42.8 | 39.2 | 46.3 |
| LISA-Llama2-13B | x | 10.24 | 20.4 | 29.2 | 27.5 | 38.5 | 10.9 | 25.6 | 14.4 | 28.4 |
| LISA-Llama2-13B_{aug} | x | 10.24 | 43.6 | 50.2 | 44.7 | 60.0 | 41.2 | 47.9 | 41.9 | 50.5 |
| PixelLM-Llama2-13B^{†} | ✓ | 6.65 | 43.0 | 51.7 | 44.8 | 61.6 | 39.3 | 44.6 | 40.5 | 48.2 |
| PixelLM-Llama2-13B | ✓ | 6.65 | 44.8 | 54.1 | 45.2 | 62.9 | 41.5 | 47.6 | 42.3 | 51.0 |

[symbol]

indicates data missing or illegible when filed

Table 2 shows a comparison of the method according to the present disclosure with other methods with respect to the reference segmentation benchmarks.

TABLE 2

| | w/o | refCOCO | | | refCOCO+ | | | refCOCOg | |
|---|---|---|---|---|---|---|---|---|---|
| | SAM | val | testA | testB | val | testA | testB | val(U) | test(U) |
| MCN | ✓ | 62.4 | 64.2 | 59.7 | 50.6 | 55.0 | 44.7 | 49.2 | 49.4 |
| VLT | ✓ | 67.5 | 70.5 | 65.2 | 56.3 | 61.0 | 50.1 | 55.0 | 57.7 |
| CRIS | ✓ | 70.5 | 73.2 | 66.1 | 62.3 | 68.1 | 53.7 | 59.9 | 60.4 |
| LAVT | ✓ | 72.7 | 75.8 | 68.8 | 62.1 | 68.4 | 55.1 | 61.2 | 62.1 |
| ReLA | ✓ | 73.8 | 76.5 | 70.2 | 66.0 | 71.0 | 57.7 | 65.0 | 66.0 |
| X-Decoder | ✓ | — | — | — | — | — | — | 64.6 | — |
| SEEM | ✓ | — | — | — | — | — | — | 65.7 | — |
| LISA | x | 74.1 | 76.5 | 71.1 | 62.4 | 67.4 | 56.5 | 66.4 | 68.5 |
| LISA_{aug} | x | 74.0 | 76.3 | 70.4 | 62.5 | 66.3 | 56.0 | 67.0 | 69.1 |
| PixelLM ^{†} | ✓ | 72.0 | 75.3 | 67.8 | 64.0 | 69.8 | 56.4 | 67.9 | 69.0 |
| PixelLM | ✓ | 73.0 | 76.5 | 68.2 | 66.3 | 71.7 | 58.3 | 69.3 | 70.5 |

Table 3 shows a comparison of the method according to the present disclosure with other methods with respect to multi-reference segmentation benchmarks.

TABLE 3

| | w/o | MrefCOCO | | | MrefCOCO+ | | | MrefCOCOg | |
|---|---|---|---|---|---|---|---|---|---|
| | SAM | val | testA | testB | val | testA | testB | val(U) | test(U) |
| LISA | x | 36.7 | 38.3 | 36.4 | 34.0 | 36.3 | 32.1 | 34.5 | 36.2 |
| LISA_{aug} | x | 68.9 | 70.8 | 66.3 | 59.8 | 62.2 | 54.1 | 62.3 | 63.9 |
| PixelLM^{†} | ✓ | 70.3 | 74.2 | 66.2 | 64.4 | 69.6 | 57.0 | 64.0 | 67.0 |
| PixelLM | ✓ | 72.7 | 76.2 | 68.1 | 65.7 | 71.3 | 57.7 | 65.8 | 67.7 |

It can be seen from tables 1 to 3 that the method according to the present disclosure is superior to the other methods in terms of efficiency and performance, and has a higher superiority by adopting feature code fusion and target refinement loss.

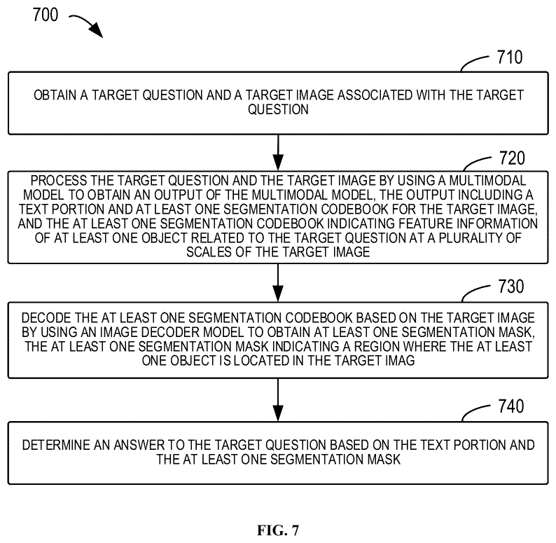

FIG. 7 illustrates a flowchart of a process 700 for multimodal data processing according to some embodiments of the disclosure. The process 700 may be implemented at the cross-modal data processing system 110 of FIG. 1, where the cross-modal data processing system 110 may include the model pre-training system 210, the model fine-adjustment system 220, and/or the model application system 230 of FIG. 2. For ease of discussion, the process 700 will be described with reference to the environment 100 of FIG. 1.

At block 710, the cross-modal data processing system 110 obtains a target question and a target image associated with the target question.

At block 720, the cross-modal data processing system 110 processes the target question and the target image by using a multimodal model to obtain an output of the multimodal model. The output includes a text portion and at least one segmentation codebook for the target image, and the at least one segmentation codebook indicates feature information of at least one object related to the target question at a plurality of scales of the target image, respectively.

At block 730, the cross-modal data processing system 110 decodes the at least one segmentation codebook based on the target image respectively by using an image decoder model to obtain at least one segmentation mask. The at least one segmentation mask indicates a region where the at least one object is located in the target image.

At block 740, the cross-modal data processing system 110 determines an answer to the target question based on the text portion and the at least one segmentation mask.

In some embodiments, processing the target question and the target image by using the multimodal model includes extracting a plurality of image features at the plurality of scales from the target image by using an image encoder model; and providing an embedded representation corresponding to the target question and the plurality of image features to the multimodal model to obtain the output of the multimodal model.

In some embodiments, decoding the at least one segmentation codebook based on the target image respectively by using the image decoder model includes: providing the plurality of image features and the at least one segmentation codebook to the image decoder model to obtain the at least one segmentation mask.

In some embodiments, decoding the at least one segmentation codebook based on the target image respectively by using the image decoder model includes: for a first segmentation codebook in the at least one segmentation codebook, obtaining a plurality of image features of the target image at the plurality of scales; determining, based on the plurality of image features and a plurality of feature information portions in the first segmentation codebook at the plurality of scales, a plurality of mask maps for a first object in the target image at the plurality of scales, respectively; and determining a first segmentation mask by merging the plurality of mask maps, the first segmentation mask map indicating a region where the first object is located in the target image.

In some embodiments, determining the plurality of mask maps for the first object in the target image at the plurality of scales includes: determining a first mask map for the first object at a first scale of the plurality of scales based on a first image feature in the plurality of image features at the first scale and a first feature information portion of the first segmentation codebook at the first scale; obtaining an updated second image feature by updating a second image feature in the plurality of image features at a second scale of the plurality of scales with the first mask map; and determining a second mask map for the first object at the second scale based on the updated second image feature and a second feature information portion of the first segmentation code book at the second scale of the plurality of scales.

In some embodiments, each segmentation codebook of the at least one segmentation codebooks includes a plurality of feature codes at respective scales of the plurality of scales. In some embodiments, determining the plurality of mask maps for the first object in the target image at the plurality of scales includes: for the plurality of scales in the first segmentation codebook, fusing a plurality of feature codes at respective scales of the plurality of scales respectively, to obtain a plurality of feature information portions at the plurality of scales.

In some embodiments, at least a portion of the image decoder model and the multimodal model are trained based on a training data set according to a predetermined loss function. The training data set includes a sample question, a sample image, a sample answer, and a plurality of true value segmentation masks for the sample image. The plurality of true value segmentation masks respectively indicate regions where a plurality of sample objects are located in the sample image.

In some embodiments, the predetermined loss function is based on at least a first loss value determined by: during a training process, determining a plurality of predictive segmentation masks for the sample image by using the multimodal model and the image decoder model in training; determining, based on the plurality of predictive segmentation masks, a weighted graph corresponding to the sample image, wherein in the weighted graph, a weighted value corresponding to a region in the sample image including at least two objects among the plurality of sample objects is greater than a weighted value corresponding to a region in the sample image including a single sample object or a region not including a sample object; and determining the first loss value by respectively weighing a plurality of difference masks between the plurality of predictive segmentation masks and the plurality of true value segmentation masks by using the weighted graph.

In some embodiments, the sample question and the sample answer are determined by: determining, based on the plurality of true value segmentation masks of the sample image, location information of a region where each of the plurality of sample objects is located in the sample image; determining a prompt word input based on the sample image and respective pieces of location information of the plurality of sample objects, the prompt word input being configured to guide generation of a question and an answer for the sample image; and providing the prompt word input to a further trained multimodal model to obtain the sample question and the sample answer output by the further multimodal model, the sample answer including an indication to one or more sample objects in the plurality of sample objects.

In some embodiments, the prompt word input is further configured to guide the further multimodal model to generate questions and answers relating to at least two objects.

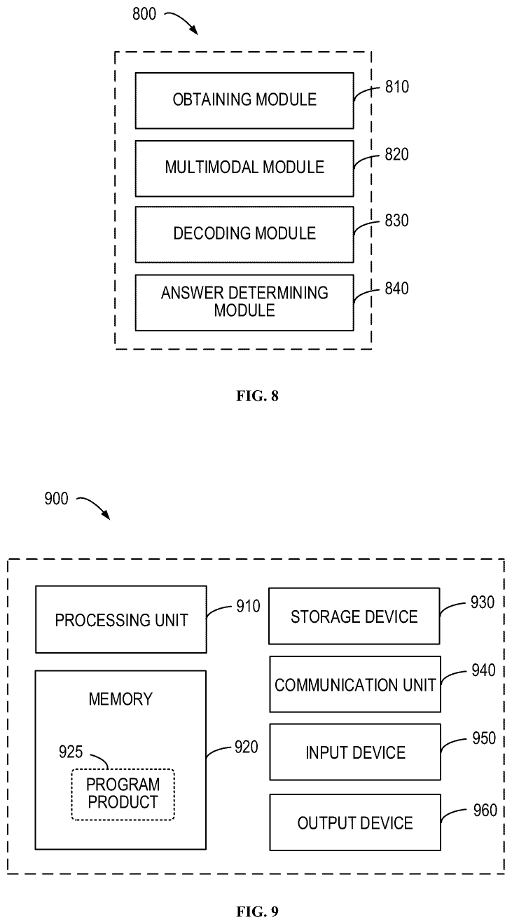

FIG. 8 illustrates a block diagram of an apparatus 800 for training a contrast learning model according to some embodiments of the disclosure. The apparatus 800 may be implemented at or included at the cross-modal data processing system 110 of FIG. 1, for example, wherein the cross-modal data processing system 110 may include the model pre-training system 210, the model fine-adjustment system 220, and/or the model application system 230 of FIG. 2. The various modules/components in apparatus 800 may be implemented by hardware, software, firmware, or any combination thereof.

As shown in FIG. 8, the apparatus 800 includes an obtaining module 810, a multimodal module 820, a decoding module 830, and an answer determining module 840. The obtaining module 810 is configured to obtain a target question and a target image associated with the target question. The multimodal module 830 is configured to process the target question and the target image by using a multimodal model to obtain an output of the multimodal model, the output including a text portion and at least one segmentation codebook for the target image, and the at least one segmentation codebook indicating feature information of at least one object related to the target question at a plurality of scales of the target image, respectively. The decoding module 830 is configured to decode the at least one segmentation codebook based on the target image respectively by using an image decoder model to obtain at least one segmentation mask, the at least one segmentation mask indicating a region where the at least one object is located in the target image. The answer determining module 840 is configured to determine an answer to the target question based on the text portion and the at least one segmentation mask.

In some embodiments, the apparatus 800 further includes an encoding module configured to extract a plurality of image features at the plurality of scales from the target image by using an image encoder model. The multimodal module 820 is also configured to provide an embedded representation corresponding to the target question and the plurality of image features to the multimodal model to obtain the output of the multimodal model.

In some embodiments, the decoding module 830 is further configured to provide the plurality of image features and the at least one segmentation codebook to the image decoder model to obtain the at least one segmentation mask.

In some embodiments, the decoding module 830 is further configured to: for a first segmentation codebook of the at least one segmentation codebook, a plurality of image features of the target image at the plurality of scales; determine, based on the plurality of image features and a plurality of feature information portions in the first segmentation codebook at the plurality of scales, a plurality of mask maps for a first object in the target image at the plurality of scales, respectively; and determine a first segmentation mask by merging the plurality of mask maps, the first segmentation mask map indicating a region where the first object is located in the target image.

In some embodiments, the decoding module 830 is further configured to: determine a first mask map for the first object at a first scale of the plurality of scales based on a first image feature in the plurality of image features at the first scale and a first feature information portion of the first segmentation codebook at the first scale; obtain an updated second image feature by updating a second image feature in the plurality of image features at a second scale of the plurality of scales with the first mask map; and determine a second mask map for the first object at the second scale based on the updated second image feature and a second feature information portion of the first segmentation codebook at the second scale of the plurality of scales.

In some embodiments, each segmentation codebook of the at least one segmentation codebooks includes a plurality of feature codes at respective scales of the plurality of scales. In some embodiments, the decoding module 830 is further configured to: for the plurality of scales in the first segmentation codebook, fuse a plurality of feature codes at respective scales of the plurality of scales respectively, to obtain a plurality of feature information portions at the plurality of scales.

In some embodiments, at least a portion of the image decoder model and the multimodal model are trained based on a training data set according to a predetermined loss function. The training data set includes a sample question, a sample image, a sample answer, and a plurality of true value segmentation masks for the sample image, and the plurality of true value segmentation masks respectively indicate regions where a plurality of sample objects are located in the sample image.

In some embodiments, the apparatus 800 further includes a loss function determining module configured to determine a predetermined loss function based at least on a first loss value determined by: during a training process, determining a plurality of predictive segmentation masks for the sample image by using the multimodal model and the image decoder model in training; determining, based on the plurality of predictive segmentation masks, a weighted graph corresponding to the sample image, wherein in the weighted graph, a weighted value corresponding to a region in the sample image including at least two objects among the plurality of sample objects is greater than a weighted value corresponding to a region in the sample image including a single sample object or a region not including a sample object; and determining the first loss value by respectively weighing a plurality of difference masks between the plurality of predictive segmentation masks and the plurality of true value segmentation masks by using the weighted graph.

In some embodiments, the apparatus 800 further includes a sample expansion module configured to determine a sample question and a sample answer by: determining, based on the plurality of true value segmentation masks of the sample image, location information of a region where each of the plurality of sample objects is located in the sample image; determining a prompt word input based on the sample image and respective pieces of location information of the plurality of sample objects, the prompt word input being configured to guide generation of a question and an answer for the sample image; and providing the prompt word input to a further trained multimodal model to obtain the sample question and the sample answer output by the further multimodal model, the sample answer including an indication to one or more sample objects in the plurality of sample objects.

In some embodiments, the prompt word input is further configured to guide the further multimodal model to generate questions and answers relating to at least two objects.

FIG. 9 illustrates a block diagram of an electronic device 900 in which one or more embodiments of the present disclosure may be implemented. It should be appreciated that the electronic device 900 shown in FIG. 9 is merely exemplary and should not constitute any limitation on the functionality and scope of the embodiments described herein. The electronic device 900 may, for example, be used to implement the cross-modal data processing system 110 of FIG. 1, wherein the cross-modal data processing system 110 may include the model pre-training system 210, the model fine-adjustment system 220, and/or the model application system 230 of FIG. 2. The electronic device 900 may also be used to implement the apparatus 800 of FIG. 8.

As shown in FIG. 9, the electronic device 900 is in the form of a general-purpose computing device. Components of the electronic device 900 may include, but are not limited to, one or more processors or processing units 910, a memory 920, a storage device 930, one or more communications units 940, one or more input devices 950, and one or more output devices 960. The processing unit 910 may be an actual or virtual processor and can perform various processes according to programs stored in the memory 920. In a multiprocessor system, a plurality of processing units execute computer executable instructions in parallel, so as to improve the parallel processing capability of the electronic device 900.

The electronic device 900 typically includes several computer storage media. Such media may be any available media that are accessible by electronic device 900, including, but not limited to, volatile and non-volatile media, removable and non-removable media. The memory 920 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 930 may be a removable or non-removable medium and may include a machine-readable medium such as a flash drive, a magnetic disk, or any other medium that can be used to store information and/or data (e. g., training data for training) and that can be accessed within the electronic device 900.

The electronic device 900 may further include additional removable/non-removable, volatile/nonvolatile storage media. Although not shown in FIG. 9, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 920 may include a computer program product 925 having one or more program modules configured to perform various methods or actions of various embodiments of the present disclosure.

The communication unit 940 implements communication with other electronic devices through a communication medium. In addition, functions of components of the electronic device 900 may be implemented by a single computing cluster or a plurality of computing machines, and these computing machines can communicate through a communication connection. Thus, the electronic device 900 may operate in a networked environment using logical connections to one or more other servers, network personal computers (PCs), or another network node.

The input device 950 may be one or more input devices such as a mouse, keyboard, trackball, etc. The output device 960 may be one or more output devices such as a display, speaker, printer, etc. The electronic device 900 may also communicate with one or more external devices (not shown) such as a storage device, a display device, or the like through the communication unit 940 as required, and communicate with one or more devices that enable a user to interact with the electronic device 900, or communicate with any device (e. g., a network card, a modem, or the like) that enables the electronic device 900 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices, and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for image question-answering, comprising:
obtaining a target question and a target image associated with the target question;
processing the target question and the target image by using a multimodal model to obtain an output of the multimodal model, the output comprising a text portion and at least one segmentation codebook for the target image, and the at least one segmentation codebook indicating feature information of at least one object related to the target question at a plurality of scales of the target image;
decoding the at least one segmentation codebook based on the target image by using an image decoder model to obtain at least one segmentation mask, the at least one segmentation mask indicating a region where the at least one object is located in the target image; and
determining an answer to the target question based on the text portion and the at least one segmentation mask.

2. The method of claim 1, wherein processing the target question and the target image by using the multimodal model comprises:
extracting a plurality of image features at the plurality of scales from the target image by using an image encoder model; and
providing an embedded representation corresponding to the target question and the plurality of image features to the multimodal model, to obtain the output of the multimodal model.

3. The method of claim 2, wherein decoding the at least one segmentation codebook based on the target image by using the image decoder model comprises:
providing the plurality of image features and the at least one segmentation codebook to the image decoder model to obtain the at least one segmentation mask.

4. The method of claim 1, wherein decoding the at least one segmentation codebook based on the target image by using the image decoder model comprises: for a first segmentation codebook in the at least one segmentation codebook,
obtaining a plurality of image features of the target image at the plurality of scales;
determining, based on the plurality of image features and a plurality of feature information portions in the first segmentation codebook at the plurality of scales, a plurality of mask maps for a first object in the target image at the plurality of scales, respectively; and
determining a first segmentation mask by merging the plurality of mask maps, the first segmentation mask map indicating a region where the first object is located in the target image.

5. The method of claim 4, wherein determining the plurality of mask maps for the first object in the target image at the plurality of scales comprises:
determining a first mask map for the first object at a first scale of the plurality of scales based on a first image feature in the plurality of image features at the first scale and a first feature information portion of the first segmentation codebook at the first scale;
obtaining an updated second image feature by updating a second image feature in the plurality of image features at a second scale of the plurality of scales with the first mask map; and
determining a second mask map for the first object at the second scale based on the updated second image feature and a second feature information portion of the first segmentation codebook at the second scale of the plurality of scales.

6. The method of claim 4, wherein each segmentation codebook of the at least one segmentation codebooks comprises a plurality of feature codes at respective scales of the plurality of scales; and
wherein determining the plurality of mask maps for the first object in the target image at the plurality of scales comprises:
for the plurality of scales in the first segmentation codebook, fusing a plurality of feature codes at respective scales of the plurality of scales respectively, to obtain a plurality of feature information portions at the plurality of scales.

7. The method of claim 1, wherein at least a portion of the image decoder model and the multimodal model are trained based on a training data set according to a predetermined loss function, the training data set comprises a sample question, a sample image, a sample answer, and a plurality of true value segmentation masks for the sample image, and the plurality of true value segmentation masks respectively indicate regions where a plurality of sample objects are located in the sample image.

8. The method of claim 7, wherein the predetermined loss function is based at least on a first loss value determined by:
during a training process, determining a plurality of predictive segmentation masks for the sample image by using the multimodal model and the image decoder model in training;
determining, based on the plurality of predictive segmentation masks, a weighted graph corresponding to the sample image, wherein in the weighted graph, a weighted value corresponding to a region in the sample image comprising at least two objects among the plurality of sample objects is greater than a weighted value corresponding to a region in the sample image comprising a single sample object or a region excluding a sample object; and
determining the first loss value by respectively weighing a plurality of difference masks between the plurality of predictive segmentation masks and the plurality of true value segmentation masks by using the weighted graph.

9. The method of claim 7, wherein the sample question and the sample answer are determined by:
determining, based on the plurality of true value segmentation masks of the sample image, location information of a region where each of the plurality of sample objects is located in the sample image;
determining a prompt word input based on the sample image and respective pieces of location information of the plurality of sample objects, the prompt word input being configured to guide generation of a question and an answer for the sample image; and
providing the prompt word input to a further trained multimodal model to obtain the sample question and the sample answer output by the further multimodal model, the sample answer comprising an indication to one or more sample objects in the plurality of sample objects.

10. The method of claim 9, wherein the prompt word input is further configured to guide the further multimodal model to generate questions and answers relating to at least two objects.

11. An electronic device, comprising:
at least one processing unit;
at least one memory, the at least one memory being coupled to the at least one processing unit and storing instructions for execution by the at least one processing unit, the instructions, when executed by the at least one processing unit, cause the electronic device to perform acts comprising:
obtaining a target question and a target image associated with the target question;
processing the target question and the target image by using a multimodal model to obtain an output of the multimodal model, the output comprising a text portion and at least one segmentation codebook for the target image, and the at least one segmentation codebook indicating feature information of at least one object related to the target question at a plurality of scales of the target image;
decoding the at least one segmentation codebook based on the target image by using an image decoder model to obtain at least one segmentation mask, the at least one segmentation mask indicating a region where the at least one object is located in the target image; and
determining an answer to the target question based on the text portion and the at least one segmentation mask.

12. The device of claim 11, wherein processing the target question and the target image by using the multimodal model comprises:
extracting a plurality of image features at the plurality of scales from the target image by using an image encoder model; and
providing an embedded representation corresponding to the target question and the plurality of image features to the multimodal model, to obtain the output of the multimodal model.

13. The device of claim 12, wherein decoding the at least one segmentation codebook based on the target image by using the image decoder model comprises:
providing the plurality of image features and the at least one segmentation codebook to the image decoder model to obtain the at least one segmentation mask.

14. The device of claim 11, wherein decoding the at least one segmentation codebook based on the target image by using the image decoder model comprises: for a first segmentation codebook in the at least one segmentation codebook,
obtaining a plurality of image features of the target image at the plurality of scales;
determining, based on the plurality of image features and a plurality of feature information portions in the first segmentation codebook at the plurality of scales, a plurality of mask maps for a first object in the target image at the plurality of scales, respectively; and
determining a first segmentation mask by merging the plurality of mask maps, the first segmentation mask map indicating a region where the first object is located in the target image.

15. The device of claim 14, wherein determining the plurality of mask maps for the first object in the target image at the plurality of scales comprises:
determining a first mask map for the first object at a first scale of the plurality of scales based on a first image feature in the plurality of image features at the first scale and a first feature information portion of the first segmentation codebook at the first scale;
obtaining an updated second image feature by updating a second image feature in the plurality of image features at a second scale of the plurality of scales with the first mask map; and
determining a second mask map for the first object at the second scale based on the updated second image feature and a second feature information portion of the first segmentation codebook at the second scale of the plurality of scales.

16. The device of claim 14, wherein each segmentation codebook of the at least one segmentation codebooks comprises a plurality of feature codes at respective scales of the plurality of scales; and
wherein determining the plurality of mask maps for the first object in the target image at the plurality of scales comprises:
for the plurality of scales in the first segmentation codebook, fusing a plurality of feature codes at respective scales of the plurality of scales respectively, to obtain a plurality of feature information portions at the plurality of scales.

17. The device of claim 11, wherein at least a portion of the image decoder model and the multimodal model are trained based on a training data set according to a predetermined loss function, the training data set comprises a sample question, a sample image, a sample answer, and a plurality of true value segmentation masks for the sample image, and the plurality of true value segmentation masks respectively indicate regions where a plurality of sample objects are located in the sample image.

18. The device of claim 17, wherein the predetermined loss function is based at least on a first loss value determined by:
during a training process, determining a plurality of predictive segmentation masks for the sample image by using the multimodal model and the image decoder model in training;
determining, based on the plurality of predictive segmentation masks, a weighted graph corresponding to the sample image, wherein in the weighted graph, a weighted value corresponding to a region in the sample image comprising at least two objects among the plurality of sample objects is greater than a weighted value corresponding to a region in the sample image comprising a single sample object or a region excluding a sample object; and
determining the first loss value by respectively weighing a plurality of difference masks between the plurality of predictive segmentation masks and the plurality of true value segmentation masks by using the weighted graph.

19. The device of claim 17, wherein the sample question and the sample answer are determined by:
determining, based on the plurality of true value segmentation masks of the sample image, location information of a region where each of the plurality of sample objects is located in the sample image;
determining a prompt word input based on the sample image and respective pieces of location information of the plurality of sample objects, the prompt word input being configured to guide generation of a question and an answer for the sample image; and
providing the prompt word input to a further trained multimodal model to obtain the sample question and the sample answer output by the further multimodal model, the sample answer comprising an indication to one or more sample objects in the plurality of sample objects.

20. A non-transitory computer readable storage medium having stored thereon a computer program, the computer program, when executed by a processor, implements acts comprising:
obtaining a target question and a target image associated with the target question;
processing the target question and the target image by using a multimodal model to obtain an output of the multimodal model, the output comprising a text portion and at least one segmentation codebook for the target image, and the at least one segmentation codebook indicating feature information of at least one object related to the target question at a plurality of scales of the target image;
decoding the at least one segmentation codebook based on the target image by using an image decoder model to obtain at least one segmentation mask, the at least one segmentation mask indicating a region where the at least one object is located in the target image; and
determining an answer to the target question based on the text portion and the at least one segmentation mask.
